(19) United States
(12) Patent Application Publication
(10) Pub. No.: US 2017/0253291 A1
(43) Pub. Date: Sep. 7, 2017

(54) DEVICE FOR FASTENING SKIS TO A BICYCLE TRAILER

(71) Applicant: CROOZER GmbH, Köln (DE)

(72) Inventor: Andreas GEHLEN, Köln (DE)

(21) Appl. No.: 15/506,189

(22) PCT Filed: Jul. 29, 2015
(86) PCT No.: PCT/EP2015/067397

§ 371 Date: Feb. 23, 2017

(30) Foreign Application Priority Data
Aug. 27, 2014 (DE) 10 2014 112 327.1

(51) Int. Cl. B62K 27/00

(52) U.S. Cl. CPC B62K 27/003

(57) ABSTRACT

The invention relates to an device for attaching a ski to a bicycle trailer, which device is characterised by: a ski-side connector piece, in the form of a ski boot sole, comprising a front and a rear insertion part for insertion into the front and rear jaws of a standard safety binding for alpine skis; means for attaching the device to the bicycle trailer; and a leg section that fixedly connects the connection piece to the attachment means.

The present invention relates to a device for mounting a ski on a bicycle trailer, a set of such devices as well as a bicycle trailer equipped therewith.

Bicycle trailers are known in varied designs. They generally have a chassis on which two running wheels are hung and which bears a drawbar. Moreover, the chassis bears a passenger compartment.

Bicycle trailers are popular particularly in their design for the transport of children since they expand the operating radius of parents, who can undertake long bicycle tours together with smaller children without overtaxing the children.

The functionality of children's bicycle trailers was expanded further in recent years in that it was possible to remove the drawbar and in addition to the two running wheels to add one or two other wheels and to provide a push handle, so that the bicycle trailer can be used as a buggy or as a so-called jogger. Such bicycle trailers are also as a rule foldable and the wheels can be removed so that they can be better transported.

The object of the present invention is to expand the possible uses of bicycle trailers in a simple and cost-effective way.

This object is achieved with a device for mounting a ski on a bicycle trailer according to claim 1. The device is characterised by a ski-side connecting piece in the manner of a ski boot sole with a front and a back insertion part for insertion into the front and the back jaws of a standardised safety binding for downhill skis, means for mounting the device on the bicycle trailer as well as a leg section securely connecting the connecting piece and the mounting means.

With such a device, the running wheels of a bicycle trailer can be exchanged for a pair of downhill skis, so that the bicycle trailer obtains stable skids. If a harness for a person is mounted on a bicycle trailer, the possibility thus results for cross-country skiers to take the children along with them in their sport in the bicycle trailer. The bicycle trailer can thus also be converted with a push handle into a push-vehicle usable in snow.

On the one hand, the ski-side connecting piece in the manner of a ski boot sole thereby makes possible a secure mounting of the ski on the device via the safety binding. On the other hand, as a result of the standardisation of the safety binding, here in particular DIN ISO 9462, and the standardised design of the front and back ends of the ski boot sole caused thereby, it is ensured that the device according to the present invention can be used with any type of ski, if it is equipped with a standardised safety binding for downhill skis. This applies by and large to any downhill ski available on the market in recent decades.

Downhill skis give the bicycle trailer a sufficiently wide contact area with comparatively low frictional resistance.

A further advantage results from the fact that no skis or other types of skids must be procured specifically for the bicycle trailer. Rather existing, used or already discarded skis can be used.

The means for mounting the device on the bicycle trailer can in principle be mechanical connecting elements such as, for example, clamps, with which the device can be mounted on a frame part of the bicycle trailer.

In an especially preferred embodiment of the device according to the present invention the trailer-side connecting piece has a kingpin, which is suited to being received in an axle slot of the bicycle trailer.

This embodiment can still be improved in that the kingpin has a quick lock for locking the kingpin in the axle slot, which can be triggered by pressing a pushbutton on the outer end face of the kingpin. An example of such an embodiment of the kingpin is known under the name pushbutton axle. The pushbutton axle has retaining balls protruding radially on its ends to be inserted, which after the insertion of the kingpin into the axle slot engage with a groove, undercut or the like introduced therein, and thus stop the axle from pulling out. To release the retaining balls a so-called dust cap, which is arranged on the running-wheel-side end of the axle, must be activated, so that the axle can be removed again from the axle slot.

Thus, it is possible to mount the device on the bicycle trailer with similar means and with similar ease, as even removable wheels on bicycle trailers. The fixing of the device in an axle slot on the bicycle trailer is perfectly adequate, even if the bicycle trailer, just like in the case of mounted wheels, can tilt somewhat forward or backward, until it sets down with its front or back part of the chassis on the ground.

In a further preferred embodiment of the device according to the present invention the ski-side connecting piece has a non-slip contact area, which counteracts a lateral swiveling of the front insertion part out of the safety binding. Unlike in the case of the soles of the ski boots, in which the contact area of the sole is supposed to be designed smoothly, particularly in the front area so that an easy release of the front safety binding transverse to the longitudinal direction of the ski is possible, it is more important for the operation with a bicycle trailer that the safety binding itself is not released with higher transverse forces or torques resulting therefrom on the ski.

In another preferred embodiment of the invention the leg section is at a substantially right angle relative to the contact area of the ski-side connecting piece. Through this, weight forces are introduced preferably directly from the bicycle trailer to the ski. Accordingly, it is an advantage if the leg section is at a substantially right angle transverse to the longitudinal direction of the ski-side connecting piece.

In particular, metallic materials, in particular aluminium or steel, glass fibre materials, carbon fibre materials or composite materials from a combination of two or more of the materials mentioned are possible as materials for the leg section as well as the mounting means.

In the case of a set made from two of the devices according to the present invention it can make sense to connect the leg sections of both devices with a cross brace for stabilising the leg sections.

The invention is explained in detail below by means of figures, which show a simple embodiment of the device according to the present invention, in which

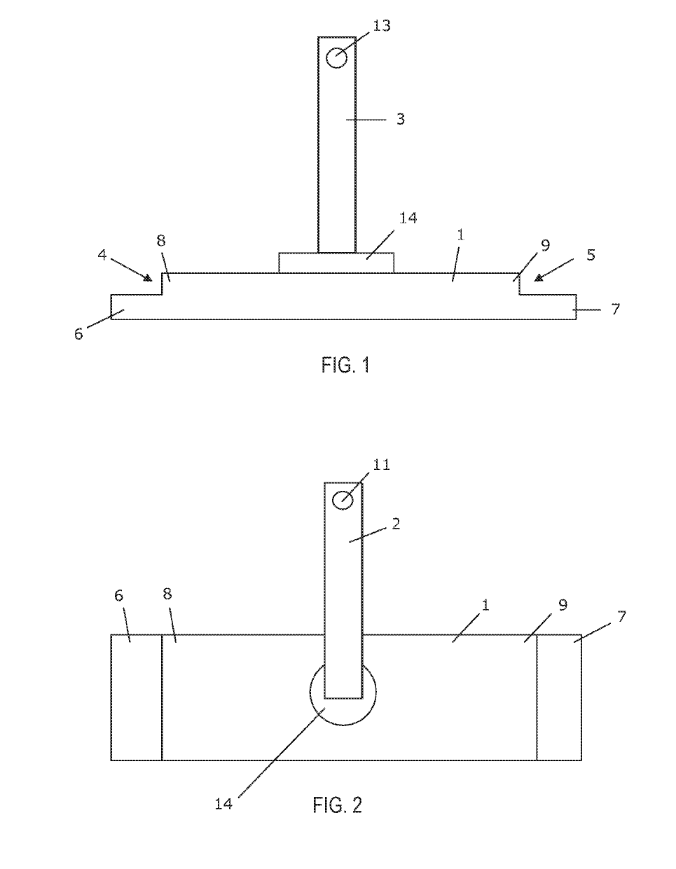

FIG. 1 shows a side view of the device according to the present invention;

FIG. 2 shows a top view of the device according to the present invention depicted in FIG. 1; and

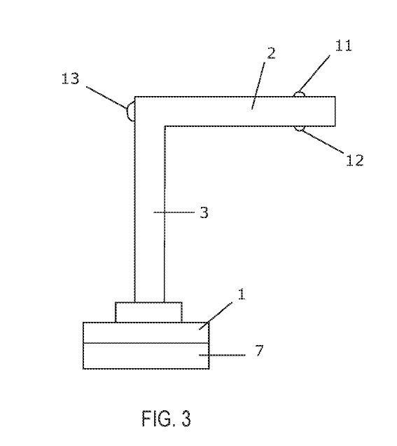

FIG. 3 shows a rear view of the device depicted in FIG. 1.

The device depicted in FIGS. 1 to 3 has a ski-side connecting piece 1, a kingpin 2 as means for mounting the device on the bicycle trailer and a leg section 3 connecting the connecting piece 1 and the kingpin 2.

The ski-side connecting piece is designed in the manner of a ski boot sole and consists of a plate with substantially rectangular cross section having a front insertion part 4 and a back insertion part 5, with which the ski-side connecting part can be inserted into a standardised safety binding for downhill skis. The insertion parts in each case have a lower base 6, 7 and a shoulder 8, 9 set thereon, which interact with the front and back part of a safety binding and with which the connecting piece can be securely held on the ski by the safety binding.

The kingpin 2 is designed as a pushbutton axle and has retaining balls 11, 12 on its free end to be inserted into the axle slot of a bicycle trailer, with which retaining balls the kingpin 2 can be locked in the axle slot. To release the retaining balls 11, 12 a dust cap 13 is provided, with the activation of which the retaining balls can be moved radially inward.

The leg section is perpendicular to the contact area of the ski-side connecting piece 1 and is connected on its lower side via a connecting flange 14 with the ski-side connecting piece. The leg section can be formed in particular from a square hollow profile or from a square solid profile.

The axle journal 2, which runs perpendicular to the leg section 3 and transversely to the longitudinal axis of the ski-side connecting piece 1, connects to its upper side. The leg section 3 and the kingpin 2 can, for example, both be produced from steel and be welded to each other.

1. A device for mounting a ski on a bicycle trailer, comprising:
a ski-side connecting piece with a front and a back insertion part configured for insertion into the front and the back jaws of a standardised safety binding for downhill skis, and
a trailer-side connecting piece coupled to the ski-side connecting piece by a leg section.

2. The device according to claim 1, wherein the trailer-side connecting piece has a kingpin, which is configured for being received in an axle slot of a bicycle trailer.

3. The device according to claim 2, wherein the kingpin has a quick lock for locking the kingpin in the axle slot, which can be triggered by pressing a pushbutton on the outer end face of the kingpin.

4. The device according to claim 1, wherein the ski-side connecting piece has a non-slip contact area, which counteracts a lateral swiveling of the front insertion part out of the safety binding.

5. The device according to claim 1 wherein the leg section coupling the ski-side connecting piece to the trailer-side connecting device is at a substantially right angle relative to the contact area of the ski-side connecting piece.

6. The device according to claim 1, wherein the leg section and the trailer-side connecting piece comprise one or more of a metallic material, a glass fiber material, a carbon fiber.

7. A system
a first device comprising
a ski-side connecting piece with a front and a back insertion part configured for insertion into the front and the back jaws of a standardized safety binding for downhill skis, and
a trailer-side connecting piece coupled to the ski-side connecting piece by a leg section;
a second device comprising
a ski-side connecting piece with a front and a back insertion part configured for insertion into the front and the back jaws of a standardized safety binding for downhill skis, and
a trailer-side connecting piece coupled to the ski-side connecting piece by a leg section; and
a cross brace for connecting and stabilizing the leg sections of the first device and the second device.

8. A bicycle trailer comprising:
a first device comprising
a ski-side connecting piece with a front and a back insertion part configured for insertion into the front and the back jaws of a standardized safety binding for downhill skis, and
a trailer-side connecting piece coupled to the ski-side connecting piece by a leg section;
a second device comprising
a ski-side connecting piece with a front and a back insertion part configured for insertion into the front and the back jaws of a standardized safety binding for downhill skis, and
a trailer-side connecting piece coupled to the ski-side connecting piece by a leg section; and
a pair of skis mounted thereon.

9. The system according to claim 7, wherein for each of the first device and the second device, the trailer-side connecting piece has a kingpin which is configured for being received in an axle slot of a bicycle trailer.

10. The system according to claim 9, wherein the kingpin has a quick lock for locking the kingpin in the axle slot, which can be triggered by pressing a pushbutton on the outer end face of the kingpin.

11. The system according to claim 10, wherein for each of the first device and the second device, the ski-side connecting piece has a non-slip contact area, which counteracts a lateral swivelling of the front insertion part out of the safety binding.

12. The system according to claim 11, wherein for each of the first device and the second device, the leg section coupling the ski-side connecting piece to the trailer-side connecting device is at a substantially right angle relative to the contact area of the ski-side connecting piece.

13. The system according to claim 11, wherein for each of the first device and the second device, the leg section and the trailer-side connecting piece comprise one or more of a metallic material, a glass fiber material, a carbon fiber.

14. The bicycle trailer according to claim 8, wherein for each of the first device and the second device, the trailer-side connecting piece has a kingpin which is configured for being received in an axle slot of a bicycle trailer.

15. The system according to claim 14, wherein the kingpin has a quick lock for locking the kingpin in the axle slot, which can be triggered by pressing a pushbutton on the outer end face of the kingpin.

16. The system according to claim 15, wherein for each of the first device and the second device, the ski-side connecting piece has a non-slip contact area, which counteracts a lateral swivelling of the front insertion part out of the safety binding.

17. The system according to claim 16, wherein for each of the first device and the second device, the leg section coupling the ski-side connecting piece to the trailer-side connecting device is at a substantially right angle relative to the contact area of the ski-side connecting piece.

18. The system according to claim 17, wherein for each of the first device and the second device, the leg section and the trailer-side connecting piece comprise one or more of a metallic material, a glass fiber material, a carbon fiber.
